(19) United States
(12) Patent Application Publication
(10) Pub. No.: US 2013/0243191 A1
(43) Pub. Date: Sep. 19, 2013

(54) ENCRYPTION KEY GENERATING APPARATUS

(71) Applicant: KABUSHIKI KAISHA TOSHIBA, Tokyo (JP)

(72) Inventors: Yuichi Komano, Kanagawa (JP); Hideo Shimizu, Kanagawa (JP); Mitsuru Kanda, Tokyo (JP); Yasuyuki Tanaka, Kanagawa (JP); Taichi Isogai, Tokyo (JP)

(73) Assignee: KABUSHIKI KAISHA TOSHIBA, Tokyo (JP)

(21) Appl. No.: 13/788,456

(22) Filed: Mar. 7, 2013

(30) Foreign Application Priority Data
Mar. 15, 2012 (JP) 2012-058554

(51) Int. Cl. H04L 9/08

(52) U.S. Cl. CPC H04L 9/0861
USPC 380/44

(57) ABSTRACT

According to an embodiment, an encryption key generating apparatus includes first to third calculators. The first calculator executes a first round operation to a first portion of first data. The second calculator executes the first round to a second portion of second data pieces. Each second data piece includes the first portion of the first data to which the first round operation has been completed and the second portion obtained by changing at least a part of the first data other than the first portion. At least a part of the second portion is different from that of each of the other second portions. The second calculator executes the first round operation to each second portion. The third calculator unit executes operations of the second and subsequent rounds to the second data pieces.

### CROSS-REFERENCE TO RELATED APPLICATIONS

This application is based upon and claims the benefit of priority from Japanese Patent Application No. 2012-058554, filed on Mar. 15, 2012; the entire contents of which are incorporated herein by reference.

### FIELD

Embodiments described herein relate generally to an encryption key generating apparatus.

### BACKGROUND

A cryptographic protocol makes use of an encryption key or an authentication key (hereinafter, collectively referred to as “encryption key”) to implement the functions of confidentiality and authentication. As a method of generating an encryption key used in a cryptographic protocol, there has been known a method of generating plural encryption keys by performing plural times a cryptographic operation based upon common key information, called master secret key.

The conventional method of generating plural encryption keys by performing plural times the cryptographic operation based upon the common key information includes repeatedly executing the same byte processing. Therefore, this conventional method has a room for improving efficiency.

### BRIEF DESCRIPTION OF THE DRAWINGS

FIG. 1 is a block diagram illustrating a configuration of an encryption key generating apparatus according to a first embodiment;

FIG. 2 is an explanatory view for explaining an operation of a first round of an AES;

FIG. 3 is a flowchart illustrating a procedure of operations of the encryption key generating apparatus according to the first embodiment;

FIG. 4 is a block diagram illustrating a configuration of an encryption key generating apparatus according to a second embodiment; and

FIG. 5 is a flowchart illustrating a procedure of operations of the encryption key generating apparatus according to the second embodiment.

### DETAILED DESCRIPTION

According to an embodiment, an encryption key generating apparatus generates plural encryption keys through an execution of a cryptographic operation based upon master secret key. The cryptographic operation is to repeat a round operation based upon a predetermined round function in a prescribed number of rounds. The encryption key generating apparatus includes a first calculator, a second calculator, and a third calculator. The first calculator is configured to perform an operation of a first round in the cryptographic operation to a first portion of first data. The second calculator is configured to perform an operation of the first round in the cryptographic operation to a second portion of each of plural pieces of second data. Each of the plural pieces of second data includes the first portion of the first data to which the operation of the first round in the cryptographic operation has been completed and the second portion that is obtained by changing at least a part of the first data other than the first portion. At least a part of the second portion is different from that of each of the other second portions. The third calculator is configured to perform operations of the second and subsequent rounds in the cryptographic operation to the plural pieces of second data to which the operation of the first round in the cryptographic operation has been completed.

An encryption key generating apparatus according to embodiments generate plural encryption keys by performing a cryptographic operation based upon key information. In the description below, an AES (Advanced Encryption Standard) will be described as an example of the cryptographic operation. The applicable cryptographic operation is not limited to the AES, but various known cryptographic operations can be employed.

An outline of the AES will firstly be described. In the AES that is the cryptographic operation of block cipher modes, a round operation using a round function is repeated the prescribed number of rounds to a data block of 128 bits (16 bytes), for example. The round function in the AES includes SubBytes, ShiftRows, MixColumns, and AddRoundKey.

The SubBytes is an operation for executing a non-linear conversion to each of 16 byte-based data that is formed by dividing 128-bit data block. The ShiftRows is an operation for rearranging the 128-bit data block on the byte basis. The MixColumns is an operation for dividing the 128-bit data block into four 32-bit data (4-byte data) and performing a matrix conversion to each of 32-bit blocks. The AddRoundKey is an operation for calculating an exclusive OR of a 128-bit round key generated by updating an initial key for each round and the 128-bit data block.

The operation of the AES is executed as described below. Firstly, a 128-bit (16-byte) plaintext block is inputted, and an exclusive OR of the inputted plaintext and a 128-bit initial key is calculated. This operation is called an initial key addition. Next, the SubBytes, the ShiftRows, the MixColumns, and the AddRoundKey are repeated in this order from the first round to the last round but one (if the prescribed round number is ten, the ninth round). On the last round, the SubBytes and the ShiftRows are executed, and then, the AddRoundKey is executed without executing the MixColumns. Then, a ciphertext block is outputted. The above description is a procedure for the encryption process. The decryption process is also executed in the same manner. In the decryption process, the ciphertext block is inputted, and the inverse conversion of the encryption process is executed in the SubBytes, the ShiftRows, and the MixColumns. Then, the plaintext block is outputted.

A key derivation function that generates plural encryption keys according to the AES operation based upon pre-shared key (PSK) information is defined in RFC 4764 (see IETF RFC 4764, “The EAP-PSK Protocol: A Pre-Shared Key Extensible Authentication Protocol (EAP) Method”, 2007; hereinafter, referred to as “Document 1”). By the key derivation function defined in RFC 4764, the AES operation using the same key information is performed to plural data blocks, only a part of which is different, so as to generate plural encryption keys.

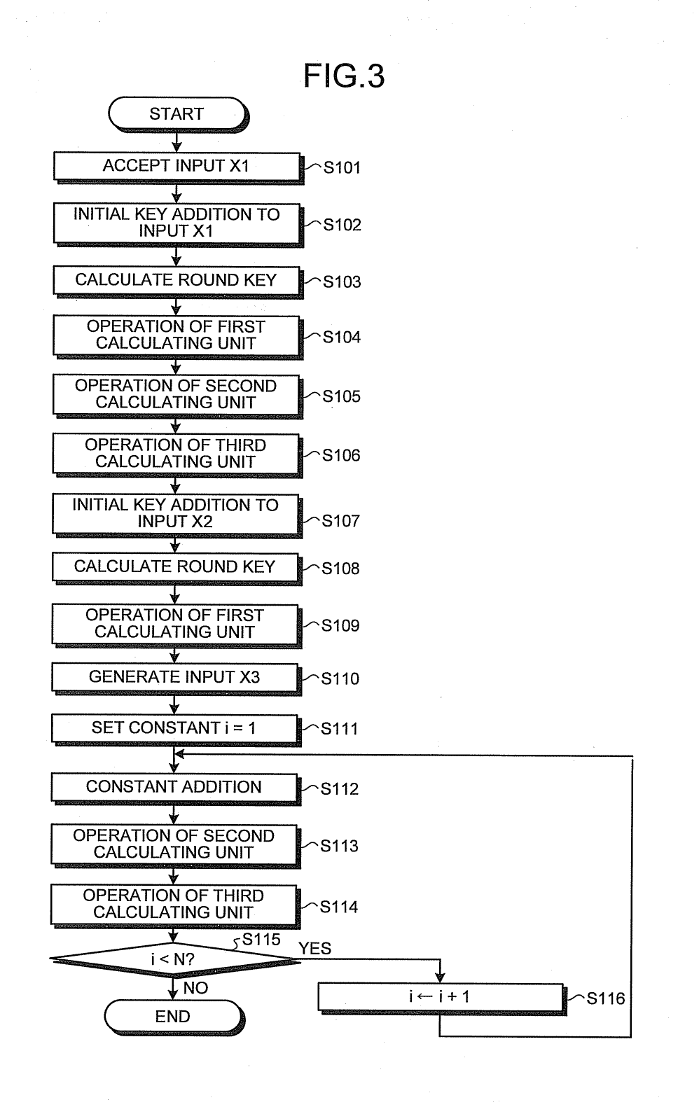

Specifically, in the key derivation function defined in RFC 4764, the AES operation based upon the pre-shared key information PSK (16 bytes) is performed to a first input “0 (16 bytes)”. Then, two second inputs, which are different from the calculation result in only the least significant byte, are generated. The AES cryptographic operation based upon the key information PSK is again executed to these two second inputs, whereby an encryption key AK and new key information KDK are generated (FIG. 3 in Document 1). Thereafter, the AES operation based upon the key information KDK is executed to a third input “RAND_P (16 bytes)”. Then, nine fourth inputs, which are different from the calculation result in only the least significant byte, are generated. The AES cryptographic operation based upon the key information KDK is again executed to these nine fourth inputs, whereby nine encryption keys of TEK, MSK1/4 to MSK4/4, and EMSK1/4 to EMSK4/4 are generated (FIG. 7 in Document 1). Accordingly, 10 encryption keys in total (each being 16 bytes) in addition to the above-mentioned encryption key AK are generated.

When the AES operation using the same key information is executed to the plural data blocks (the second input or fourth input), a part of which is only different, as in the key derivation function defined in RFC 4764, the same byte processing is executed redundantly to the portion common to the plural data blocks. Therefore, this has to be improved from the viewpoint of processing efficiency. The encryption key generating apparatus according to embodiments reduces a processing amount by collectively executing the byte processing to the common part of the plural data blocks, when the AES operation using the same key information is executed to the plural data blocks, a part of which is only different, as in the key derivation function defined in RFC 4764. Accordingly, the encryption key generating apparatus according to embodiments can efficiently generate plural encryption keys.

### First Embodiment

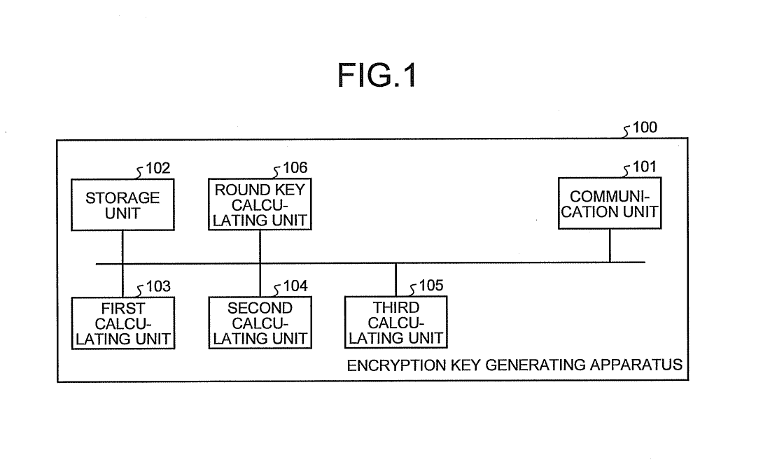

FIG. 1 is a block diagram illustrating a configuration of an encryption key generating apparatus 100 according to a first embodiment. The encryption key generating apparatus 100 includes a communication unit 101, a storage unit 102, a first calculating unit 103, a second calculating unit 104, a third calculating unit 105, and a round key calculating unit 106. In addition, the encryption key generating apparatus 100 includes a control unit controlling the apparatus and a computation unit calculating an exclusive OR, but they are not illustrated in the figure.

The communication unit 101 is an interface establishing communication between the encryption key generating apparatus 100 and an external system.

The storage unit 102 stores therein key information PSK shared between the encryption key generating apparatus 100 and the external system, and a procedure of the operations performed by the encryption key generating apparatus 100.

The first calculating unit 103 performs an operation of a first round in the AES to a first portion of first data. If the first data is applied to the description related to the key derivation function defined in RFC 4764, the first data is the data as a result of the calculation of the AES operation based upon the key information PSK (16 bytes) to the first input “0 (16 bytes)”, or the data as a result of the calculation of the AES operation based upon the key information KDK to the third input “RAND_P (16 bytes)”. The first portion is a portion to which the common byte processing is to be executed in the operation of the first round in the AES, i.e., the portion excluding a process unit including the least significant byte of the data of the calculation result.

The second calculating unit 104 executes the operation of the first round in the AES to a second portion of each of plural pieces of second data. The second data includes the first portion of the first data to which the operation of the first round in the AES has already been executed, and also includes the second portion that is obtained by changing at least a part of the first data other than the first portion. At least a part of the second portion is different from that of each of the other second portions. The second calculating unit 104 executes the operation of the first round in the AES to the second portion of each of plural pieces of second data. If the second data is applied to the description related to the key derivation function defined in RFC 4764, the second data is the second input or the fourth input to which the operation of the first round in the AES to the first portion has already been executed. The second portion is a process unit including the least significant byte of the second input or the fourth input.

The third calculating unit 105 executes operations of the second and subsequent rounds to the plural pieces of second data to which the operation of the first round in the AES has already been executed.

The round key calculating unit 106 accepts the initial key as an input, and calculates a round key in the number corresponding to the prescribed rounds of the AES. For example, the prescribed number of rounds is 10, the round key calculating unit 106 calculates ten 16-byte round keys corresponding to the first round to the tenth round of the AES.

The encryption key generating apparatus 100 according to the first embodiment collectively performs the byte processing, which has been independently performed in the conventional case, in the operation of the first round in the AES to the plural pieces of second data by the first calculating unit 103, and executes the byte processing to the remaining portions (second portion) by the second calculating unit 104, thereby enhancing processing efficiency. The operation performed by the first calculating unit 103 and the operation performed by the second calculating unit 104 will specifically be described below, in accordance with the key derivation function defined in RFC 4764. In the AES, the calculation result is the same even if the SubBytes and the ShiftRows are executed in the reverse order. Therefore, it is supposed below that the SubBytes is executed after the ShiftRows is executed. In the round functions of the AES, the ShiftRows is an operation of shift on a byte basis, and this is an operation for the whole 16 bytes. Therefore, the ShiftRows for the whole 16 bytes in the first round is supposed to be executed first by the first calculating unit 103.

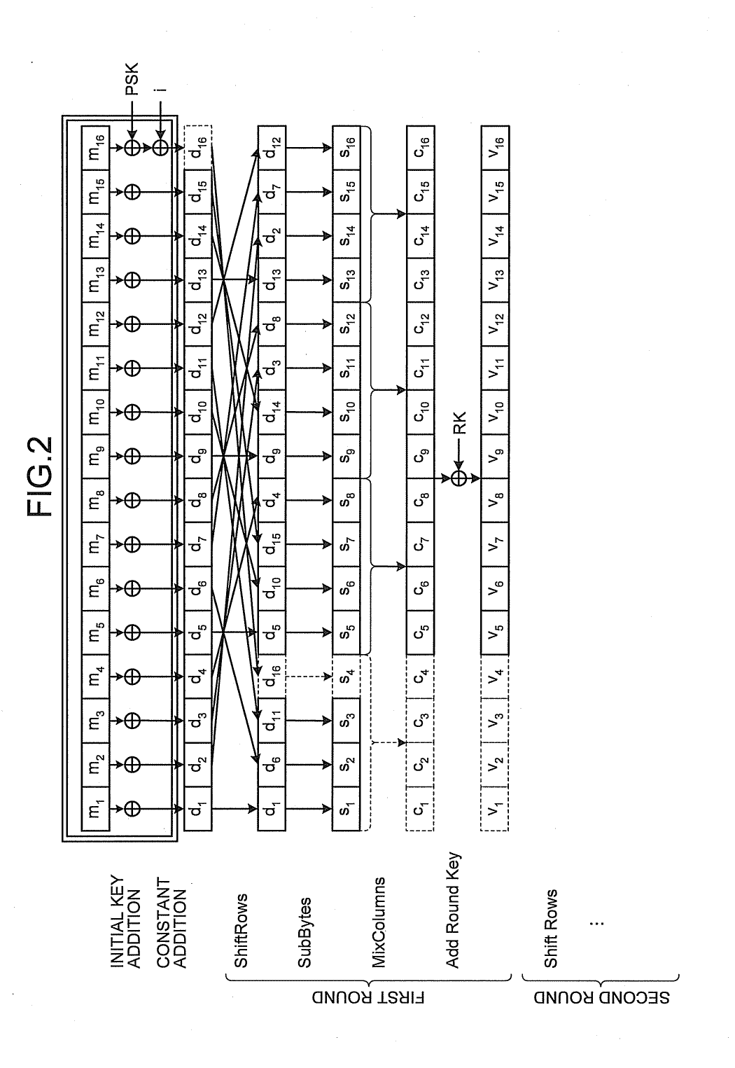

FIG. 2 is an explanatory view for describing the operation of the first round in the AES to the second input or the fourth input in the key derivation function defined in RFC 4764.

Firstly, an exclusive OR of a calculation result m (m₁ to m₁₆: an index indicates the byte position from the head) of the AES to the first input or the third input and the pre-shared key information PSK is calculated (an initial key addition). For the least significant byte m₁₆, the exclusive OR of the result of the exclusive OR of the key information. PSK and the least significant byte of a constant i (in FIG. 3 in Document 1, i=1, or 2, and in FIG. 7 in Document 1, i=1 to 9) is calculated (constant addition). This result becomes the second input or the fourth input d (d₁ to d₁₆: an index indicates the byte position from the head).

Next, the ShiftRows is executed to the second input or the fourth input d in the first round of the AES. As a result, intermediate data is obtained in which data is arranged in the order of d₁, d₆, d₁₁, d₁₆, d₅, d₁₀, d₁₅, d₄, d₉, d₁₄, d₃, d₈, d₁₃, d₂, d₇, and d₁₂ from the head. The SubBytes is executed to this intermediate data, whereby intermediate data s (s₁ to s₁₆: an index indicates the byte position from the head) to which a non-linear processing is applied on a byte basis is obtained. In addition, the MixColumns is executed to the intermediate data s to obtain intermediate data c (c₁ to c₁₆: an index indicates the byte position from the head) in which the matrix conversion is performed for each 4 bytes. Then, the exclusive OR of the intermediate data c and the round key RK generated by the round key calculating unit 106 is calculated (AddRoundKey), whereby intermediate data v (v₁ to v₁₆: an index indicates the byte position from the head) is obtained. Thereafter, the same operation is repeated with the intermediate data v generated in the first round being used as an input in the second round of the AES.

In the example illustrated in FIG. 2, the second input or the fourth input d that is the input in the first round of the AES is data of which least significant byte d₁₆ is only different by the constant addition. Therefore, in the first round of the AES, the common byte processing is executed to the portion (first portion) that is not affected by the least significant byte d₁₆ of the second input or the fourth input. The encryption key generating apparatus 100 according to the first embodiment performs the common byte processing by the first calculating unit 103, and performs the byte processing to the remaining portion by the second calculating unit 104. In FIG. 2, the portion to be processed by the first calculating unit 103 is indicated by a solid line, and the portion to be processed by the second calculating unit 104 is indicated by a broken line. The initial key addition and the constant addition enclosed by a double line in FIG. 2 are operations executed before the first round.

The first calculating unit 103 performs the ShiftRows operation in the first round of the AES, the SubBytes operation of a predetermined byte, the corresponding MixColumns operation, and the AddRoundKey of the corresponding byte. In the ShiftRows operation, the 1st, 6th, 11th, and 16th bytes are associated with the 1st to 4th bytes, respectively; the 5th, 10th, 15th, and 4th bytes are associated with the 5th to 8th bytes, respectively; the 9th, 14th, 3rd, and 8th bytes are associated with the 9th to 12th bytes, respectively; and the 13th, 2nd, 7th, and 12th bytes are associated with the 13th to 16th bytes, respectively. The SubBytes operation is the SubBytes of the 1st to 3rd bytes, and the 5th to 16th bytes. The corresponding MixColumns operation includes three MixColumns, which are a second MixColumns using the 5th to 8th bytes, a third MixColumns using the 9th to 12th bytes, and a fourth MixColumns using the 13th to 16th bytes. In the corresponding AddRoundKey, 4 bytes outputted by the second MixColumns are defined as the 5th to 8th bytes, 4 bytes outputted by the third MixColumns are defined as the 9th to 12th bytes, and 4 bytes outputted by the fourth MixColumns are defined as the 13th to 16th bytes; and an exclusive OR of the 5th to 16th bytes and the 5th to 16th bytes of the round key (16 bytes) in the first round generated by the round key calculating unit 106 is calculated.

The second calculating unit 104 performs the SubBytes operation of the bytes that are not processed by the first calculating unit 103 in the first round of the AES, the corresponding MixColumns operation, and the corresponding AddRoundKey. In the example illustrated in FIG. 2, the byte that is not processed by the first calculating unit 103 is the least significant byte d₁₆ of the second input or the fourth input, i.e., the 4th byte after the ShiftRows operation. The corresponding MixColumns operation is the first MixColumns operation using the 1st to 4th bytes after the ShiftRows operation. The corresponding AddRoundKey sets the 4 bytes outputted by the first MixColumns as the 1st to 4th bytes, and calculates the exclusive OR of the 1st to 4th bytes and the 1st to 4th bytes of the round key (16 bytes) in the first round generated by the round key calculating unit 106.

Next, the procedure of the operations performed by the encryption key generating apparatus 100 according to the first embodiment will be described with reference to FIG. 3, taking, as an example, a case where plural encryption keys are generated in accordance with the key derivation function defined in RFC 4764. FIG. 3 is a flowchart illustrating the procedure of the operations performed by the encryption key generating apparatus 100.

In the key derivation function defined in RFC 4764, the AES operation to the first input or the third input is executed before the AES operation to the second input or the fourth input is executed, as described above. Different from the second input or the fourth input, the least significant byte of the first input or the third input is not changed by the constant addition. However, since the AES operation is executed by the first calculating unit 103, the second calculating unit 104, and the third calculating unit 105 in the encryption key generating apparatus 100 according to the first embodiment, the operation corresponding to the AES operation to the first input or the third input is also executed by the first calculating unit 103, the second calculating unit 104, and the third calculating unit 105. In the flowchart in FIG. 3, the operations performed in steps S104 to S106 correspond to the AES operation to the first input or the third input, while the operations performed in steps S109, S113, and S114 correspond to the AES operation to the second input or the fourth input.

Firstly, the encryption key generating apparatus 100 accepts a predetermined input X1 (step S101). For example, when the operation corresponding to that of FIG. 3 in Document 1 is executed, the encryption key generating apparatus 100 accepts the first input “0 (16 bytes)”, and when the operation corresponding to that of FIG. 7 in Document 1 is executed, the encryption key generating apparatus 100 accepts the third input “RAND_P (16 bytes)”.

Next, the encryption key generating apparatus 100 calculates an exclusive OR of the input X1 accepted in step S101 and the key information PSK stored in the storage unit 102 (initial key addition) (step S102).

Next, the round key calculating unit 106 calculates the round key (RK) by using the key information PSK stored in the storage unit 102 as an input (step S103). The round key calculating unit 106 may calculate the round key RK corresponding to the round in each case according to the round processed by the first calculating unit 103, the second calculating unit 104, and the third calculating unit 105. Alternatively, the round key calculating unit 106 may calculate the round key RK of the corresponding round, and may store the calculated round key RK in the storage unit, before the first calculating unit 103, the second calculating unit 104, and the third calculating unit 105 execute the operation. The encryption key generating apparatus 100 may allow the storage unit 102 to store the round key RK calculated by the round key calculating unit 106, in case that the round key RK is again used in the subsequent AES operation. When the storage unit 102 does not store the round key RK, the round key calculating unit 106 calculates the required round key, every time the round operation is executed. However, this will not be described below.

Next, the first calculating unit 103 calculates 16 bytes in total, which are the 1st to 3rd bytes to which the operation up to the SubBytes has been performed in the first round in the AES, the 4th byte to which the operation up to the ShiftRows has been performed, and the 5th to 16th bytes of the output of the first round in the AES, by using a 16-byte input X1′ to which the initial key addition is performed in step S102, and the round key RK of the first round calculated in step S103 as inputs (step S104).

Next, the second calculating unit 104 calculates the 1st to 4th bytes of the output of the first round in the AES by using, as inputs, the 1st to 4th bytes out of 16-byte data calculated in step S104 and the round key RK of the first round calculated in step S103 (step S105). The operation in step S104 and the operation in step S105 may be executed in the different order, or may simultaneously be executed.

Next, the third calculating unit 105 repeats the operations of the second to tenth rounds in the ABS so as to calculate a ciphertext (16 bytes) of the ABS corresponding to the input X1 accepted in step S101, by using the 16 bytes of the output in the first round of the ABS calculated in steps S104 and S105 and the round key RK calculated in step S103 as inputs (step S106).

Next, the encryption key generating apparatus 100 uses the 16-byte ciphertext calculated in step S106 as an input, and calculates an exclusive OR of the input X2 and the key information PSK stored in the storage unit 102 (initial key addition) (step S107).

Next, the round key calculating unit 106 calculates the round key RK by using the key information PSK stored in the storage unit 102 as an input as in step S103 (step S108). When the round key RK calculated by the round key calculating unit 106 in step S103 is stored in the storage unit 102, the operation in step S108 may be omitted.

Next, the first calculating unit 103 calculates the 1st to 3rd bytes to which the operation up to the SubBytes has been performed in the first round in the AES, the 4th byte to which the operation up to the ShiftRows has been performed, and the 5th to 16th bytes of the output in the first round of the AES, by using a 16-byte input X2′ to which the initial key addition is performed in step S107, and the round key RK in the first round calculated in step S108 (or in step S103) as inputs (step S109).

Next, the encryption key generating apparatus 100 concatenates the 1st to 4th bytes to the 5th to 16th bytes in the 16-byte data calculated in step S109, thereby generating a 16-byte input X3 (step S110).

Next, the encryption key generating apparatus 100 repeats the operation described below for a predetermined number of times. For example, when the operation corresponding to that of FIG. 3 in Document 1 is executed, the repeated number is 2, and when the operation corresponding to that of FIG. 7 in Document 1 is executed, the repeated number is 9. The repeated number is represented by N. The repeated state is represented as i such as i=1, i=2, i=N. The symbol i indicating the repeated state is a constant used in the later-described constant addition.

Firstly, the encryption key generating apparatus 100 sets as constant i=1 (step S111).

Next, the encryption key generating apparatus 100 calculates an exclusive OR of the 16-byte input X3 generated in step S110 and the constant i (constant addition) (step S112).

Next, the second calculating unit 104 calculates the 1st to 4th bytes in the output in the first round of the AES by using the 1st to 4th bytes of the input X3 to which the constant addition is performed on the 4th byte in step S112, and the round key RK in the first round calculated in step S108 (or in step S103) as inputs. The second calculating unit 104 concatenates the 5th to 16th bytes of the input X3 to the 1st to 4th bytes, thereby generating the output in the first round of the AES corresponding to the input X3 (step S113).

Next, the third calculating unit 105 repeats the operations of the second to tenth rounds in the AES so as to calculate the ciphertext (16 bytes) of the AES corresponding to the input X3, by using the 16 bytes of the output in the first round of the AES calculated in steps S113 and the round key RK calculated in step S108 (or in step S103) as inputs (step S114). The ciphertext calculated here becomes the encryption key generated based upon the key information PSK, or the key information KDK for generating many encryption keys.

Thereafter, the encryption key generating apparatus 100 determines whether i is less than N or not (step S115). When i is less than N (step S115: Yes), the encryption key generating apparatus 100 replaces i by i+1 (step S116), and returns to step S112 to repeat the operations in step S112 and in the subsequent steps. On the other hand, when i reaches N (step S115: No), the encryption key generating apparatus 100 ends a series of operations.

As described in detail by using the specific example, in the encryption key generating apparatus 100 according to the first embodiment, when plural encryption keys are generated by the execution of the AES operation using the same key information to plural data blocks, which are only partially different, the first calculating unit 103 collectively performs the byte processing to the portion common to the plural data blocks in the first round of the AES, and the second calculating unit 104 performs the byte processing to the remaining portion (second portion). Therefore, the encryption key generating apparatus 100 according to the first embodiment can reduce total processing amount for generating the plural encryption keys, thereby being capable of efficiently generating plural encryption keys.

It has been described above that plural encryption keys are generated in accordance with the key derivation function defined in RFC 4764 described in Document 1. However, the encryption key generating apparatus 100 is similarly applicable to a case where plural encryption keys are generated by a counter mode of a block cipher described in NIST SP800-38a, “Recommendation for Block Cipher Modes of Operation—Methods and Techniques”, 2001, and the same effect as that described above can be obtained. When plural encryption keys are generated by the counter mode of the block cipher, the operations in steps S101 to S106 in FIG. 3 are skipped, and the operations after step S107 are executed with the input to the counter mode being used as an input X2.

It has been described above that the constant addition executed in step S112 in FIG. 3 is the exclusive OR. However, other calculations may be employed instead of the exclusive OR, such as addition or multiplication in GF (256). In the above description, the AES is used as the cryptographic operation. However, other cryptographic operations may be used. Alternatively, a system in which an input is divided and processed may be used.

The repeated operation in steps S111 to S116 in FIG. 3 may be executed in a different order with respect to i, or may be executed in parallel. For example, the operation corresponding to step S113 may be executed for i=1 to N, and then, the operation corresponding to step S114 may be executed for i=1 to N. As for the operation in step S114, in particular, the operation in step S114 for each i may progress for each round as described below. Specifically, the operation in step S114 for each i is divided for each round, and the operation corresponding to the second round in the AES is executed for i=1 to N. Then, the operation corresponding to the third round in the AES is executed for i=1 to N. By matching the round in the repeated operation as described above, the number of times of generating and reading the round key RK can be reduced.

### Second Embodiment

The second embodiment is an example in which a countermeasure technique (hereinafter referred to as a side-channel countermeasure) against side-channel attacks, such as SPA (Simple Power Analysis) or DPA (Differential Power Analysis), is incorporated into the configuration in the first embodiment. As representative side-channel countermeasures, there have been known a countermeasure for hiding intermediate data, which is currently undergoing an encryption process, by using a random number (random mask), and a countermeasure of performing a linear conversion to each byte of the intermediate data that is currently undergoing an encryption process.

Countermeasure Using Random Mask

In this countermeasure, the intermediate data that is currently undergoing the encryption process is processed with a random mask being XORed. For this, a new conversion table in which the random mask is XORed with each of the input and output of the conversion table used when the random mask is not used is created in the SubBytes in the AES, and the non-linear conversion is executed by utilizing this new conversion table. A different random mask may be used for each of the input and output of the SubBytes. Alternatively, a different random mask may be used for each byte.

In the MixColumns in the AES, the random mask XORed with the byte outputted by the MixColumns is determined depending on the random mask XORed with the 4 bytes of the input of the MixColumns. For example, when MSK1 to MSK4 are XORed with each of 4 bytes inputted to the MixColumns, the random masks XORed with the 1st to 4th bytes of the output of the MixColumns can be represented as (0x2*MSK1)+(0x3*MSK2)+MSK3+MSK4, (0x3*MSK1)+MSK2+MSK3+(0x02*MSK4), MSK1+MSK2+(0x02*MSK3)+(0x03*MSK4), and MSK1+(0x2*MSK2)+(0x03*MSK3)+MSK4. It is to be noted that 0x02 and 0x03 are 2 and 3 in hexadecimal notation, and * means multiplication with GF(256).

When the countermeasure using the random mask is applied, the random masks XORed with the intermediate data that is currently undergoing the encryption process are specified as described above, and these random masks are removed through the exclusive OR operation, whereby a correct ciphertext corresponding to the input can be calculated.

Countermeasure using linear conversion In this countermeasure, a linear conversion f is performed for each byte of intermediate data that is currently undergoing the encryption process. The linear conversion f means a conversion in which an exclusive OR of f(a) and f(b) of two bytes a and b, and an output when an exclusive OR of a and b is inputted to f agree with each other. In the SubBytes in the AES, a new conversion table in which f(SubBytes(a)) corresponds to f(a) is created, and the non-linear conversion is performed by utilizing this new conversion table.

In the MixColumns in the AES, 0x02 calculating table in which f(0x02*a) is outputted to f(a) is newly created, and the new conversion table is utilized for 0x02 calculation. 0x03 calculation can be made by the reference result of the 0x02 calculating table to the data f(a) and the exclusive OR with f(a).

The encryption key generating apparatus according to the second embodiment employs the countermeasure using the random mask or the countermeasure using the linear conversion as the side-channel countermeasure, thereby enhancing safety to the side-channel attack.

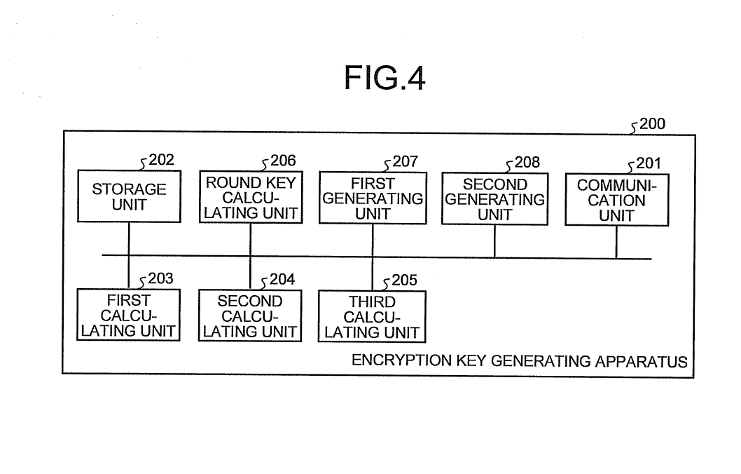

FIG. 4 is a block diagram illustrating a configuration of an encryption key generating apparatus 200 according to the second embodiment. The encryption key generating apparatus 200 includes a communication unit 201, a storage unit 202, a first calculating unit 203, a second calculating unit 204, a third calculating unit 205, a round key calculating unit 206, a first generating unit 207, and a second generating unit 208. In addition, the encryption key generating apparatus 200 includes a control unit controlling the apparatus and a computation unit calculating an exclusive OR, but they are not illustrated in the figure.

The communication unit 201 is an interface establishing communication between the encryption key generating apparatus 200 and an external system.

The storage unit 202 stores therein key information PSK shared between the encryption key generating apparatus 200 and the external system, countermeasure data generated in the first generating unit 207 and the second generating unit 208, and a procedure of the operations performed by the encryption key generating apparatus 200.

The first calculating unit 203 performs an operation of a first round in the AES to a first portion of first data, like the first calculating unit 103 in the first embodiment. It is to be noted that the first calculating unit 203 performs a SubBytes operation, MixColumns operation, and AddRoundKey corresponding to the countermeasure applied as the side-channel countermeasure for the encryption key generating apparatus 200.

The second calculating unit 204 executes the operation of the first round in the AES to a second portion of each of plural pieces of second data, like the second calculating unit 104 in the first embodiment. It is to be noted that the second calculating unit 204 performs a SubBytes operation, MixColumns operation, and AddRoundKey corresponding to the countermeasure applied as the side-channel countermeasure for the encryption key generating apparatus 200.

The third calculating unit 205 executes operations of second and subsequent rounds to the plural pieces of second data to which the operation of the first round in the AES has already been executed, like the third calculating unit 105 in the first embodiment. It is to be noted that the third calculating unit 205 performs a SubBytes operation, MixColumns operation, and AddRoundKey corresponding to the countermeasure applied as the side-channel countermeasure for the encryption key generating apparatus 200.

The round key calculating unit 206 accepts the initial key as an input, and calculates a round key in the number corresponding to the prescribed rounds of the AES, like the round key calculating unit 106 in the first embodiment.

The first generating unit 207 generates a random mask or a conversion rule (linear conversion f) for a linear conversion required in the side-channel countermeasure for the encryption key generating apparatus 200. Specifically, when the countermeasure using the random mask is applied as the side-channel countermeasure for the encryption key generating apparatus 200, the first generating unit 207 generates the random mask used for the side-channel countermeasure. When the countermeasure using the linear conversion is applied as the side-channel countermeasure for the encryption key generating apparatus 200, the first generating unit 207 generates the linear conversion f used for the side-channel countermeasure. When the side-channel countermeasure is made by using the random mask or the linear conversion f that has already been generated and stored in the storage unit 202, the encryption key generating apparatus 200 may not have the first generating unit 207.

The second generating unit 208 generates information for the cryptographic operation corresponding to the side-channel countermeasure using the random mask or linear conversion f generated by the first generating unit 207. Specifically, when the countermeasure using the random mask is applied as the side-channel countermeasure for the encryption key generating apparatus 200, the second generating unit 208 generates a new conversion table for the SubBytes processed by the first calculating unit 203, the second calculating unit 204, and the third calculating unit 205, or generates the random mask used in the MixColumns. When the countermeasure using the linear conversion is applied as the side-channel countermeasure for the encryption key generating apparatus 200, the second generating unit 208 generates a new conversion table for the SubBytes processed by the first calculating unit 203, the second calculating unit 204, and the third calculating unit 205, or generates a new calculating table used in the MixColumns.

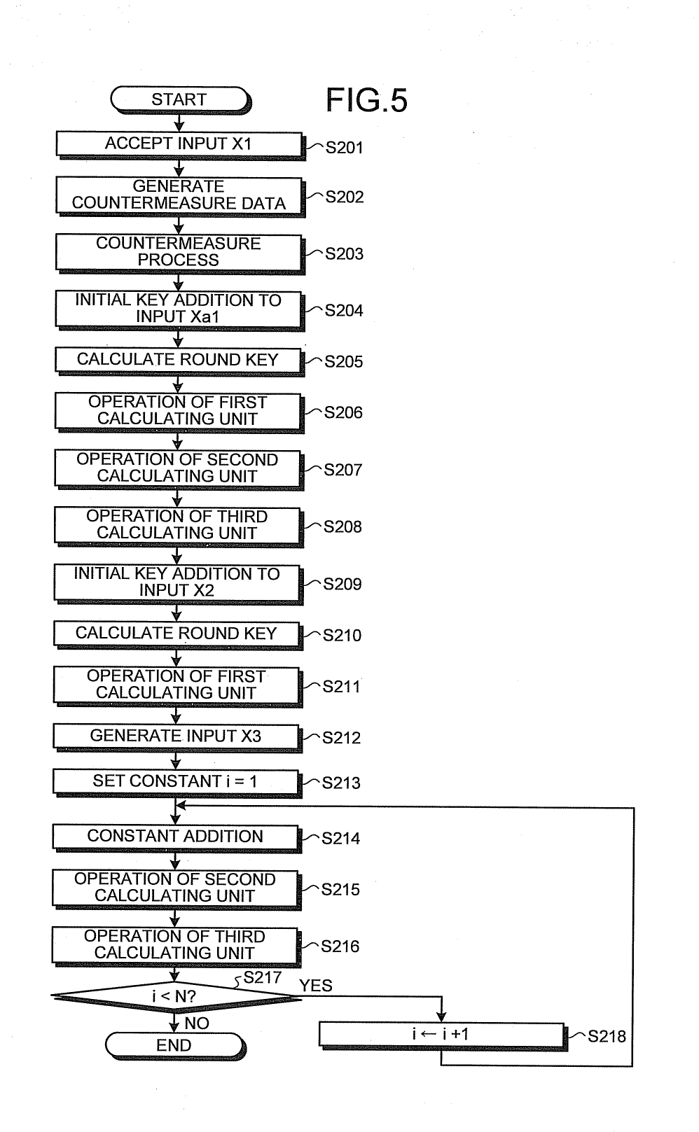

Next, the procedure of the operations performed by the encryption key generating apparatus 200 according to the second embodiment will be described with reference to FIG. 5, taking, as an example, the case where plural encryption keys are generated in accordance with the key derivation function defined in RFC 4764. FIG. 5 is a flowchart illustrating the procedure operations performed by the encryption key generating apparatus 200.

Firstly, the encryption key generating apparatus 200 accepts a predetermined input X1 (step S201). For example, when the operation corresponding to that of FIG. 3 in Document 1 is executed, the encryption key generating apparatus 200 accepts the first input “0 (16 bytes)”, and when the operation corresponding to that of FIG. 7 in Document 1 is executed, the encryption key generating apparatus 200 accepts the third input “RAND_P (16 bytes)”.

Next, the first generating unit 207 generates a random mask or linear conversion f used for the side-channel countermeasure, and the second generating unit 208 generates the new conversion table for the SubBytes or the random mask or new calculating table used in the MixColumns for executing the AES operation corresponding to the side-channel countermeasure using the random mask or the linear conversion f generated by the first generating unit 207 (step S202). The random mask or the linear conversion f generated by the first generating unit 207 and the conversion table generated by the second generating unit 208 are collectively referred to as countermeasure data below. Specifically, the first generating unit 207 and the second generating unit 208 generate the countermeasure data required for the side-channel countermeasure in step S202.

Next, the encryption key generating apparatus 200 performs, to the input X1 accepted in step S201, a process (hereinafter referred to as a countermeasure process) for the side-channel countermeasure using the random mask or the linear conversion f generated in step S202 (step S203). Specifically, when the countermeasure using the random mask is applied as the side-channel countermeasure, the encryption key generating apparatus 200 calculates an exclusive OR of the input X1 accepted in step S201 and the random mask generated in step S202. When the countermeasure using the linear conversion is applied as the side-channel countermeasure, the encryption key generating apparatus 200 inputs the input X1 accepted in step S201 into the linear conversion f generated in step S202, and calculates its output.

Next, the encryption key generating apparatus 200 performs the initial key addition to the input Xa1 to which the countermeasure process is performed in step S203 (step S204). Specifically, when the countermeasure using the random mask is applied as the side-channel countermeasure, the encryption key generating apparatus 200 calculates an exclusive OR of the input Xa1 to which the countermeasure process is performed and the key information PSK stored in the storage unit 202. When the countermeasure using the linear conversion is applied as the side-channel countermeasure, the encryption key generating apparatus 200 calculates an exclusive OR of the input Xa1 to which the countermeasure is performed and a value obtained by inputting the key information PSK stored in the storage unit 202 into the linear conversion f generated in step S202.

Next, the round key calculating unit 206 calculates the round key RK by using the key information PSK stored in the storage unit 202 as an input (step S205). The timing of calculating the round key RK or whether the storage unit 202 is used or not is the same as in step S103 in the first embodiment. When the countermeasure using the linear conversion is applied as the side-channel countermeasure, the encryption key generating apparatus 200 calculates the round key RK by utilizing the linear conversion f generated in step S202.

Next, the first calculating unit 203 calculates the 1st to 3rd bytes to which the operation up to the SubBytes has been performed in the first round of the AES, the 4th byte to which the operation up to the ShiftRows has been performed, and the 5th to 16th bytes of the output in the first round of the AES, in the state in which the side-channel countermeasure is performed, by using the 16-byte data Xa1′ to which the initial key addition is performed in step S204 and the round key RK in the first round calculated in step S205 as inputs (step S206). In this case, the first calculating unit 203 performs the SubBytes operation by utilizing the conversion table generated by the second generating unit 208 in step S202, and performs the MixColumns operation by utilizing the random mask or the new calculating table generated by the second generating unit 208 in step S202.

Next, the second calculating unit 204 calculates the 1st to 4th bytes of the output in the first round of the AES in the state in which the side-channel countermeasure is performed, by using the 1st to 4th bytes of the 16-byte data calculated in step S206, and the round key RK of the first round calculated in step S205 as inputs (step S207). In this case, the second calculating unit 204 performs the SubBytes operation by utilizing the conversion table generated by the second generating unit 208 in step S202, and performs the MixColumns operation by utilizing the random mask or the new calculating table generated by the second generating unit 208 in step S202. The operation in step S206 and the operation in step S207 may be executed in the reverse order, or may be executed in parallel.

Next, the third calculating unit 205 repeats the operations of the second to tenth rounds in the ABS so as to calculate the ciphertext (16 bytes) of the ABS corresponding to the input X1 accepted in step S201, by using the 16 bytes of the output in the first round of the AES, which are calculated in steps S206 and S207 and to which the side-channel countermeasure is performed, and the round key RK calculated in step S205 as inputs (step S208). In this case, the third calculating unit 205 performs the SubBytes operation by utilizing the conversion table generated by the second generating unit 208 in step S202, and performs the MixColumns operation by utilizing the random mask or the new calculating table generated by the second generating unit 208 in step S202. The third calculating unit 205 may output the ciphertext from which the countermeasure process by the random mask or the linear conversion f is removed in step S208, or may output the ciphertext with the countermeasure process by the random mask or the linear conversion f being performed in step S208. When the ciphertext from which the countermeasure process by the random mask or the linear conversion f is removed is outputted in step S208, new countermeasure data is generated by the first generating unit 207 and the second generating unit 208 as in step S202, and the countermeasure process same as that in step S203 is performed to the ciphertext outputted in step S208. However, these processes are not illustrated in FIG. 5.

Next, the encryption key generating apparatus 200 uses the 16-byte ciphertext outputted in step S208 as an input X2, and performs the initial key addition to the input X2 (step S209). Specifically, when the countermeasure using the random mask is applied as the side-channel countermeasure, the encryption key generating apparatus 200 calculates an exclusive OR of the input Xa2 and the key information PSK stored in the storage unit 202. When the countermeasure using the linear conversion is applied as the side-channel countermeasure, the encryption key generating apparatus 200 calculates an exclusive OR of the input Xa2 and a value obtained by inputting the key information PSK stored in the storage unit 202 into the linear conversion f.

Next, the round key calculating unit 206 calculates the round key RK by using the key information PSK stored in the storage unit 202 as an input, as in step S205 (step S210). When the round key RK calculated in step S205 by the round key calculating unit 206 is stored in the storage unit 202, the operation in step S210 may be omitted.

Next, the first calculating unit 203 calculates the 1st to 3rd bytes to which the operation up to the SubBytes has been performed in the first round of the AES, the 4th byte to which the operation up to the ShiftRows has been performed, and the 5th to 16th bytes in the first round of the AES, in the state in which the side-channel countermeasure is performed, by using the 16-byte input X2′ to which the initial key addition is performed in step S209 and the round key RK in the first round calculated in step S210 (or in step S205) as inputs (step S211). In this case, the first calculating unit 203 performs the SubBytes operation by utilizing the conversion table generated by the second generating unit 208 in step S202, and performs the MixColumns operation by utilizing the random mask or the new calculating table generated by the second generating unit 208 in step S202.

Next, the encryption key generating apparatus 200 concatenates the 1st to 4th bytes to the 5th to 16th bytes of the 16-byte data calculated in step S211 to generate 16-byte input X3 (step S212).

Next, the encryption key generating apparatus 200 repeats the operation described below for a predetermined number of times. For example, when the operation corresponding to that of FIG. 3 in Document 1 is executed, the repeated number is 2, and when the operation corresponding to that of FIG. 7 in Document 1 is executed, the repeated number is 9. The repeated number is represented by N. The repeated state is represented as i such as i=1, i=2, . . . i=N. The symbol i indicating the repeated state is a constant used in the later-described constant addition.

Firstly, the encryption key generating apparatus 200 sets as constant i=1 (step S213).

Next, the encryption key generating apparatus 200 calculates (constant addition) an exclusive OR of the 4th byte of the 16-byte input X3 generated in step S212 and the least significant byte of the constant i (step S214). When the countermeasure using the linear conversion is applied as the side-channel countermeasure, the encryption key generating apparatus 200 increments f(i) by using the linear conversion f generated in step S202.

Next, the second calculating unit 204 calculates the 1st to 4th bytes of the output in the first round of the AES by using the 1st to 4th bytes of the input X3 to which the constant addition is performed on the 4th byte in step S214, and the round key RK in the first round calculated in step S210 (or in step S205) as inputs. The second calculating unit 204 concatenates the 5th to 16th bytes of the input X3 to the 1st to 4th bytes, thereby generating the output in the first round of the AES corresponding to the input X3 in a state in which the side-channel countermeasure is performed (step S215). In this case, the second calculating unit 204 performs the SubBytes operation by utilizing the conversion table generated by the second generating unit 208 in step S202, and performs the MixColumns operation by utilizing the random mask or the new calculating table generated by the second generating unit 208 in step S202.

Next, the third calculating unit 205 repeats the operations of the second to tenth rounds in the AES so as to calculate the ciphertext (16 bytes) of the AES corresponding to the input X3, by using the 16 bytes of the output in the first round of the AES calculated in steps S215 and the round key RK calculated in step S210 (or in step S205) as inputs (step S216). In this case, the third calculating unit 205 performs the SubBytes operation by utilizing the conversion table generated by the second generating unit 208 in step S202, and performs the MixColumns operation by utilizing the random mask or the new calculating table generated by the second generating unit 208 in step S202. The third calculating unit 205 outputs the ciphertext from which the countermeasure process by the random mask or the linear conversion f is removed in step S216. The ciphertext outputted here becomes the encryption key generated based upon the key information PSK, or the key information KDK for generating many encryption keys.

Thereafter, the encryption key generating apparatus 200 determines whether i is less than N or not (step S217). When i is less than N (step S217: Yes), the encryption key generating apparatus 200 replaces i by i+1 (step S218), and returns to step S214 to repeat the operations in step S214 and in the subsequent steps. On the other hand, when i reaches N (step S217: No), the encryption key generating apparatus 200 ends a series of operations.

As described in detail by using the specific example, in the encryption key generating apparatus 200 according to the second embodiment, when plural encryption keys are generated by the execution of the AES operation using the same key information to plural data blocks, which are partially different, the first calculating unit 203 collectively performs the byte processing to the portion common to the plural data blocks in the operations of the first round in the AES, and the second calculating unit 204 performs the byte processing to the remaining portion (second portion). Therefore, the encryption key generating apparatus 200 according to the second embodiment can reduce total processing amount for generating the plural encryption keys, thereby being capable of efficiently generating plural encryption keys.

The encryption key generating apparatus 200 according to the second embodiment realizes the AES operation in a state in which the side-channel countermeasure using the random mask or the linear conversion is performed. Therefore, the encryption key generating apparatus 200 can enhance safety to the side-channel attack.

In the above description, either one of the countermeasure using the random mask and the countermeasure using the linear conversion is applied as the side-channel countermeasure. However, both of the countermeasure using the random mask and the countermeasure using the linear conversion may be applied. When both of the countermeasure using the random mask and the countermeasure using the linear conversion are used, the estimation of the key information is made more difficult, whereby the safety to the side-channel attack can be enhanced more.

The first embodiment and the second embodiment have been described above. The encryption key generating apparatus described in each embodiment can be configured by employing a hardware structure utilizing a general computer, wherein the major functions such as the first calculating units 103 and 203, the second calculating units 104 and 204, the third calculating units 105 and 205, the round key calculating units 106 and 206, the first generating unit 207, and the second generating unit 208 are realized by a program executed by the computer.

The above-described program realizing the major functions of the encryption key generating apparatus is provided as being recorded on a computer-readable recording medium, such as CD-ROM, flexible disk (FD), CD-R, or DVD (Digital Versatile Disk), in a file of an installable form or a file of an executable form.

The above-described program realizing the major functions of the encryption key generating apparatus may be stored on a computer connected to network such as the Internet, and provided as being downloaded through the network. The above-described program realizing the major functions of the encryption key generating apparatus may also be provided or distributed through the network such as the Internet. The program realizing the major functions of the encryption key generating apparatus may be provided as being installed on a ROM beforehand.

The program realizing the major functions of the encryption key generating apparatus has a module structure including components corresponding to the respective functional configurations (first calculating units 103, 203, the second calculating units 104, 204, the third calculating units 105, 205, the round key calculating units 106, 206, the first generating unit 207, the second generating unit 208). As an actual hardware, a CPU (processor) reads the program from the memory medium and executes the program, whereby the respective components are loaded on a main memory, and the respective function units of the encryption key generating apparatus are formed on the main memory.

As described in detail by using the specific examples, the encryption key generating apparatus according to the embodiments can efficiently generate plural encryption keys.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An encryption key generating apparatus that generates plural encryption keys through an execution of a cryptographic operation based upon master secret key, where the cryptographic operation repeats a round operation based upon a predetermined round function in a prescribed number of rounds,
the encryption key generating apparatus comprising:
a first calculator to perform an operation of a first round in the cryptographic operation to a first portion of first data;
a second calculator to perform an operation of the first round in the cryptographic operation to a second portion of each of plural pieces of second data, wherein each of the plural pieces of second data includes the first portion of the first data to which the operation of the first round in the cryptographic operation has been completed and the second portion that is obtained by changing at least a part of the first data other than the first portion, and wherein at least a part of the second portion is different from that of each of the other second portions; and
a third calculator to perform operations of the second and subsequent rounds in the cryptographic operation to the plural pieces of second data to which the operation of the first round in the cryptographic operation has been completed.

2. The apparatus according to claim 1, wherein the first data is data as a result of the cryptographic operation to input data.

3. The apparatus according to claim 1, further comprising:
a first generating unit to generate a random number used for a side-channel countermeasure; and
a second generating unit to generate information for executing the cryptographic operation including the side-channel countermeasure by using the random number, wherein
the first calculator and the second calculator execute the operation of the first round in the cryptographic operation by using the random number generated by the first generating unit and the information generated by the second generating unit, and
the third calculator executes the operations of the second and subsequent rounds in the cryptographic operation by using the random number generated by the first generating unit and the information generated by the second generating unit.

4. The apparatus according to claim 1, further comprising:
a first generating unit to generate a conversion rule of a linear conversion used for a side-channel countermeasure; and
a second generating unit to generate information for executing the cryptographic operation including the side-channel countermeasure by using the conversion rule of the linear conversion, wherein
the first calculator and the second calculator execute the operation of the first round in the cryptographic operation by using the conversion rule of the linear conversion and the information, and
the third calculator unit executes the operations of the second and subsequent rounds in the cryptographic operation by using the conversion rule of the linear conversion and the information.
